(19) United States
(12) Patent Application Publication
(10) Pub. No.: US 2006/0273176 A1
(43) Pub. Date: Dec. 7, 2006

(54) Blocking contactless personal security device

(75) Inventors: Yves Louis Gabriel Audebert, Los Gatos, CA (US); Wu Wen, Sunnyvale, CA (US)

Correspondence Address: STEVENS, DAVIS, MILLER & MOSHER, LLP, 1615 L. STREET, NW SUITE 850, WASHINGTON, DC, 20036, US

(73) Assignee: ActivIdentity, Inc., Fremont, CA (US)

(21) Appl. No.: 11/446,132

(22) Filed: Jun. 5, 2006

Related U.S. Application Data
(60) Provisional application No. 60/687,150, filed on Jun. 3, 2005.

(51) Int. Cl. G06K 7/08

(52) U.S. Cl. 235/451

(57) ABSTRACT

A blocking Personal Security Device (PSD) is disclosed which is intended to protect the privacy of one or more contactless PSDs present within a common RF field generated by a contactless PSDs RF reader. The blocking PSD is programmed to exploit an anti-collision protocol used by the RF reader. The blocking PSD prevents the RF reader from accessing a contactless PSD within the common RF field by ignoring wait time commands and repeatedly responding to the RF reader's interrogations.

### FIELD OF THE INVENTION

The present invention relates generally to a security method and a Personal Security Device (PSD), and more specifically to a method and blocking PSD to block unauthorized access to a contactless PSD.

The blocking PSD and/or the contactless PSD may be a blocking contactless smartcard, or a Radio Frequency Identification (RFID) tag.

### BACKGROUND OF THE INVENTION

Contactless smart cards and RFID tags provide significant flexibility and ease of use for both physical and logical implementations (e.g., access control badges, network login, banking, etc.). However, contactless cards are always available for access leaving the possibility of unauthorized access to occur. Security issues arise since the cards and RFID tags can be read remotely (i.e., without being swiped or obviously scanned) by anyone equipped with a proper Radio Frequency (RF) reader without the cardholder's permission or knowledge.

For several reasons, card reader systems are designed so that the distance between the contactless card and the reader is kept to a minimum. However, the card may still be interrogated at a greater distance using a high-gain antenna.

This current design limitation is inherent in contactless cards and RFID tags which rely on a properly encoded RF field generated by a RF reader for power and communications. To protect the card from unauthorized access, simple RF shielding arrangements such as Faraday cages have been proposed.

However, RF shielding sufficient to prevent unauthorized card interrogation generally requires an opaque metal covering sufficient to encompass the wire antenna installed in a plastic matrix of the contactless card. This arrangement hinders the usefulness of the smart card as a visual identification badge and creates unnecessary inconvenience to the user.

Other suggested security features propose to incorporate a cryptographic protocol between the contactless cards and card readers. For example, RSA Laboratories proposes, as one solution to the privacy issue, to reprogram each RFID tag to carry multiple, random-looking names.

Each time it is queried, the RFID tag releases a different name, which limits access to only a valid reader, since only the valid reader would be able to determine if two different names belong to the same tag, (“Minimalist Cryptography for Low-Cost RFID Tags”, by A. Juels, 2004). The suggested cryptographic protocol option would be effective; however, implementation would require the costly reprogramming of both contactless cards and card readers.

In another approach, RSA Laboratories proposes a “blocker tag” arrangement which forces the RFID tags or contactless card reader to iteratively exhaust the entire range of expected identifiers out of a field of available RFID tags or contactless cards (“The Blocker Tag: Selective Blocking of RFID Tags for Consumer Privacy”, A. Juels, R. Rivest and M. Szydio, 2003). This mechanism provides a more viable alternative since it is compatible with existing RFID tags or contactless cards and provides an alternate method of exploiting the most common anti-collision protocols currently in use today. However, one disadvantage of this arrangement is the requirement for the “blocker tag” to iteratively respond (i.e. selective response) to each increasing bit level provided by the interrogating RF reader. While not particularly difficult to implement, the cost for each “blocker tag” is increased since additional programming is necessary to mirror the requested bit sequence received from the interrogating RF reader.

Therefore, a simple and inexpensive mechanism to prevent unauthorized access to a contactless smart card or RFID tag, more generally to a contactless PSD, without having to envelop the card or RFID tag in a metal shield or without requiring significant reprogramming of existing contactless devices, would be highly desirable.

### BRIEF SUMMARY OF THE INVENTION

The invention provides a method for blocking unauthorized access by a RF reader to a first contactless PSD located within a RF field generated by said RF reader. Said RF reader and said first contactless PSD include an anti-collision protocol logic for enabling the RF reader to selectively access said first contactless PSD among a plurality of contactless PSDs located within said RF field. A blocking contactless PSD is also provided with the first contactless PSD within said RF field, said blocking contactless PSD non-selectively responding to each interrogation provided by said RF reader.

Therefore the invention provides a blocking PSD solution to prevent unauthorized access to contactless smart cards and like devices. The blocking PSD described in this invention exploits the anti-collision protocol by providing a non-selective response to each interrogation provided by a RF reader.

According to the anti-collision protocol, each interrogation may include a wait time command to delay the response of all non-selected contactless PSDs within the RF field. In that case, said blocking PSD non-selectively responds to each interrogation by ignoring said wait time command.

In a preferred embodiment, said blocking PSD non-selectively responds to each interrogation of said RF reader as if it was selected, each time said RF reader is ready to communicate with the next contactless PSD in a queue of selected contactless PSDs.

Said blocking PSD may non-selectively responds to each interrogation of said RF reader by emitting one of the data selected from the set including a white noise, non sensical data, an internal identifier and an acknowledgement signal.

The invention further provides a blocking PSD comprising:
A transponder circuit for receiving interrogation signals from a RF reader when located within a RF field generated by said RF reader and for sending responses thereto,
A microprocessor interacting with a blocking logic for generating a non-selective response to each interrogation signal from said RF reader even if said interrogation signal is compliant with an anti-collision protocol logic for enabling the RF reader to selectively access a first contactless PSD among a plurality of contactless PSDs also located within said RF field.

The blocking PSD may include a switch or a state placement device for activation or de-activation of its blocking logic.

It may also comprise a display for indicating the state of its blocking logic as activated or de-activated. This display can be for instance a Light Emitting Diode (LED).

Possible implementations of the blocking PSD include a Radio Frequency Identification (RFID) tag, a smart card, and a sticker containing said transponder circuit and said microprocessor interacting with said blocking logic.

The benefit of a sticker or other type of interface is that it could be used with any card to protect skimming of confidential information.

The blocking PSD may also be imbedded in one of the elements of the set including a wallet, plain paper and cloth.

The features and advantages of the invention will become apparent from the following detailed description when considered in conjunction with the accompanying drawings.

Where possible, the same reference numerals and characters are used to denote like features, elements, components or portions of the invention. Optional components are generally shown in dashed lines. It is intended that changes and modifications can be made to the described embodiment without departing from the true scope and spirit of the subject invention as defined in the claims.

### BRIEF DESCRIPTION OF THE DRAWINGS

FIG. 1 is a generalized block diagram depicting a RF reader, a contactless PSD and a blocking PSD which comprise elements of the invention.

FIG. 2 is a simplified block diagram depicting a polling of all contactless PSDs within the RF field of the RF reader.

FIG. 2A is a simplified block diagram depicting a collision between the contactless PSD and blocking PSD.

FIG. 2B is a simplified block diagram depicting an anti-collision wait state command being issued by the RF reader to all contactless PSDs within its RF field.

FIG. 2C is a simplified block diagram depicting a re-polling of the contactless PSDs within the RF field of the RF reader.

FIG. 2D is a simplified block diagram depicting the blocking PSD ignoring the anti-collision protocol and continuing to respond to the RF reader.

### DETAILED DESCRIPTION OF THE INVENTION

This invention addresses the inherent limitations of existing contactless smart cards and like devices (more generally referred as contactless PSDS) by exploiting an anti-collision protocol used by a RF reader to selectively access a single contactless PSD from a plurality of contactless PSDs within communications range of the RF reader. For example, in a package of RFID tagged goods passing through a check out line, in a group of people passing through a ticket gate at or near the same time, in a group of travelers passing through a customs checkpoint having contactless smart card enabled passports, or in a group of employees passing through a security kiosk, each card or tag must be individually selected by the RF reader to complete a transaction.

The most common anti-collision protocol for contactless smart cards is based on the ISO-14443 standard series. This anti-collision protocol provides ordered and sequential access to the RF reader using a single communication channel. Depending on the specific anti-collision protocol employed, a random wait time, specific encoding or a recursive wait time is used to delay the response of all non-selected cards until chosen by the RF reader for a transaction.

The objective of the anti-collision protocol is to ensure that all cards within the RF field of the RF reader can eventually establish communications with the RF reader on a one-to-one basis. If a non-conforming chip or RF circuit ignores the anti-collision protocol, communications with the RF reader would not be possible, thus preventing access to a selected contactless card or like device. This invention exploits the anti-collision protocol to allow an inexpensive blocking PSD, for instance a chip card, to prevent communications with its contactless PSD counterpart, for instance a smart card, by an unauthorized contactless card or RFID reader.

In an embodiment of the invention, the blocking PSD is designed to exploit the anti-collision protocol so that it is always selected by the RF reader after the latter is ready to communicate to the next card or chip in a queue. This is achieved by reprogramming the blocking PSD wait time or countdown to “0” rather than some random non-zero value employed in some anti-collision protocols such as the various ALHOA-based protocols. By setting the wait time to “0”, the blocking PSD is always the next device to respond to subsequent RF reader interrogations which prevents the RF reader from establishing communications with any cards or tags within the same localized RF field.

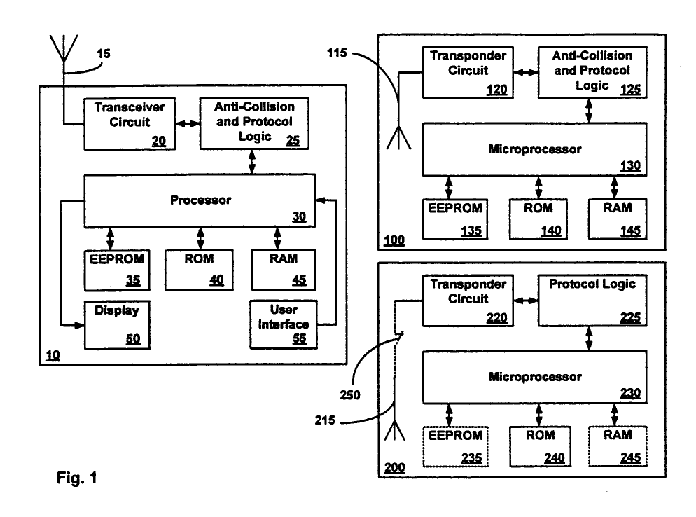

Referring to FIG. 1, a RF reader 10 is depicted. The RF reader 10 includes a transceiving antenna 15 coupled to a transceiver circuit 20. The transceiver circuit 20 is coupled to an anti-collision and communications protocol logic 25 configured to communicate with one or more compatible contactless smart cards 100.

Various types of anti-collision mechanisms are provided for contactless cards including time division multiplexing where a wait time is established before a contactless card 100 responds to an interrogation by a RF reader 10 or code division multiplexing where each contactiess card 100 shares the same RF spectrum with other contactless cards but are individually and uniquely encoded.

The anti-collision and communications protocol logic 25 is executed by a processor 30 of the RF reader 10. The processor 30 has coupled thereto one or more memory storage types including EEPROM 35, ROM 40 and RAM 45. A display 50 and user interface 55 are provided to allow a user to execute transactions with one or more contactless smart cards 100.

The contactless smart card 100 includes an internal antenna 115 coupled to a transponder circuit 120.

The transponder circuit 120 is coupled to an anti-collision and communications protocol logic 125; the transponder circuit 120 and anti-collision and communications protocol logic 125 being compatible with that of the RF reader 10. The anti-collision and communications protocol logic 125 is executed by a microprocessor 130 associated with the contactless smart card 100. The microprocessor 130 has coupled thereto one or more memory storage types including EEPROM 135, ROM 140 and RAM 145.

The contactless card includes a tuned L/C circuit (not shown) coupled to the antenna 115 to convert the RF signal received from the RF reader 10 into electrical energy which drives the transponder circuit 120 and the microprocessor 130.

The blocking PSD 200 includes an internal antenna 215 coupled to a transponder circuit 220. The transponder circuit 220 is coupled to a protocol logic 225 executable by an internal microprocessor 230. The blocking PSD 200 lacks or otherwise ignores anti-collision mechanisms and may provide a white noise, nonsensical data, an internal identifier, acknowledgement signal or selected response to the RF reader 10. The blocking PSD 200 includes a ROM 240 but may optionally lack EEPROM 235 and RAM 245 since the functionality of the PSD is limited to simply blocking functions.

The continued presence of a properly encoded transponder signal prevents access to the contactless smart card 100 by interfering with the RF reader's 10 ability to progress beyond its anti-collision protocol, so long as the blocking PSD 200 remains in close proximity to the contactless smart card 100. Therefore, it is important that the blocking PSD 200 remains in close proximity to the contactless smart card 100.

The blocking PSD 200 may optionally include a contact switch or state placement device 250 which allows activation and de-activation of the blocking mechanism when desired by the card holder. As a result, the contactless smart card 100 cannot be surreptitiously read by unauthorized RF readers. The blocking PSD 200 may also comprise a display for indicating the state of its blocking logic as activated or de-activated. This display can be for instance a Light Emitting Diode (LED).

The blocking PSD 200 may be fashioned into any convenient form factor. For example, the blocking PSD 200 may be embodied in a removable patch or sticker for placement on or near an actual contactless smart card or chip, in a traditional plastic credit card arrangement or any other convenient form factor. It may also be embedded in many forms, including a wallet, plain paper, cloth or other device such as a reader.

The blocking PSD 200 may be generated during the production run as a counterpart to the contactless smart card 100. In the simplest embodiment of the invention, the blocking PSD 200 is nearly identical to the actual contactless smart card 100 with exception of the anti-collision logic either being disabled or programmed to ignore wait state commands from the RF reader 10.

In another embodiment of the invention, the blocking PSD 200 is simply a wideband oscillator circuit which may be modulated with white noise to effectively “jam” encoded transmissions from the contactless smart card 100.

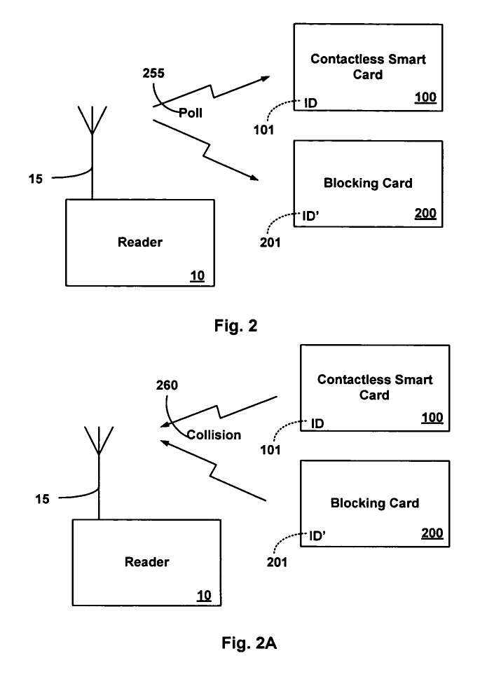

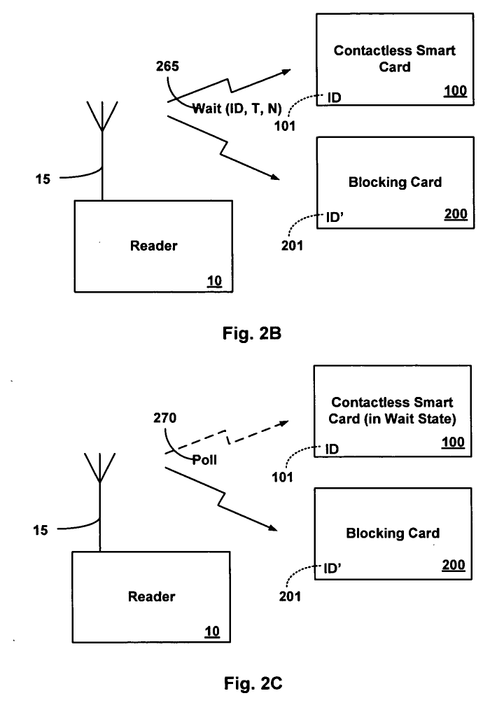

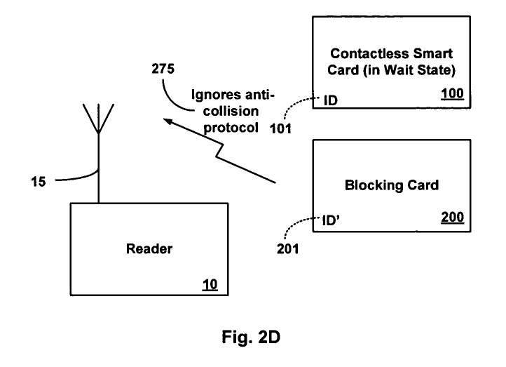

Referring to FIG. 2, an exemplary transaction between a RF reader 10, a contactless smart card 100 and a blocking PSD 200 is depicted. In this exemplary transaction, the RF reader 10 generates a properly encoded RF carrier 255 which causes both the contactless smart card 100 and the blocking PSD 200 to become active.

In an embodiment of the invention which is dependent on the type of anti-collision mechanism employed, identical card identity numbers ID, ID′ 101, 201 are provided for the contactless smart card 100 and the corresponding blocking PSD 200.

Referring to FIG. 2A, once activated, both the contactless smart card 100 and the blocking PSD 200 respond to the polling request 255 resulting in a collision 260 at the RF reader 10.

Referring to FIG. 2B, the RF reader 10 detects the collision between the contactless smart card 100 and blocking PSD 200 and transmits a properly encoded wait or sleep command 265 to the contactless smart card 100.

The actual command sent by the PSD reader 10 is dependent on the anti-collision protocol employed. In general, the command may be specifically directed toward a particular card identifier 101, 102, provides a wait time or initiates a watchdog timer inside the contactless smart card 100. Other anti-collision mechanisms may also be employed.

Referring to FIG. 2C, in this exemplary transaction, the wait time command is actually received by the contactless smart card 100, placing the smart card 100 in a sleep state. It is immaterial whether the contactless smart card 100 is actually placed in a wait state, since this would repeat the scenario described under the discussion accompanying FIG. 2B. The RF reader then re-polls 270 to determine if the collision has been resolved.

Referring to FIG. 2D, since the blocking PSD 200 either lacks the anti-collision protocol or is otherwise programmed to ignore the anti-collision protocol 275, a properly encoded response is returned to the RF reader 10 which prevents the RF reader 10 from exiting its anti-collision loop. The presence of a response 275 causes the RF reader 10 to repeat the anti-collision loop, thus preventing access to the contactless smart card 100.

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks. No specific limitation is intended to a particular security system or arrangement.

What is claimed:

1. A method for blocking unauthorized access by a Radio Frequency (RF) reader (10) to a first contactless Personal Security Device (PSD) (100) located within a RF field generated by said RF reader, said RF reader and said first contactless PSD including an anti-collision protocol logic (25, 125) for enabling the RF reader to selectively access said first contactless PSD among a plurality of contactless PSDs (100, 200) located within said RF field, wherein a blocking contactless PSD (200) is also provided with the first contactless PSD within said RF field, said blocking contactless PSD non-selectively responding to each interrogation provided by said RF reader.

2. The method of claim 1, wherein each interrogation includes a wait time command to delay the response of all non-selected contactless PSDs within the RF field, and wherein said blocking PSD non-selectively responds to each interrogation by ignoring said wait time command.

3. The method of claim 1, wherein said blocking PSD non-selectively responds to each interrogation of said RF reader as if it was selected, each time said RF reader is ready to communicate with the next contactless PSD in a queue of selected contactless PSDs.

4. The method of claim 1, wherein said blocking PSD non-selectively responds to each interrogation of said RF reader by emitting one of the data selected from the set including a white noise, non sensical data, an internal identifier and an acknowledgement signal.

5. A blocking Personal Security Device (PSD) (200) comprising:
A transponder circuit (220) for receiving interrogation signals from a Radio Frequency (RF) reader (10) when located within a RF field generated by said RF reader and for sending responses thereto,
A microprocessor (230) interacting with a blocking logic (225) for generating a non-selective response to each interrogation signal from said RF reader even if said interrogation signal is compliant with an anti-collision protocol logic (25) for enabling the RF reader to selectively access a first contactless PSD (100) among a plurality of contactless PSDs (100, 200) also located within said RF field.

6. The blocking PSD of claim 5, including a switch or a state placement device for activation or de-activation of its blocking logic.

7. The blocking PSD of claim 6, further comprising a display for indicating the state of its blocking logic as activated or de-activated.

8. The blocking PSD of claim 7, wherein said display is a Light Emitting Diode (LED).

9. The blocking PSD of claim 5, implemented as an element of the set including a Radio Frequency Identification (RFID) tag, a smart card, and a sticker containing said transponder circuit and said microprocessor interacting with said blocking logic.

10. The blocking PSD of claim 5, imbedded in one of the elements of the set including a wallet, plain paper and cloth.
